(19) United States
(12) Patent Application Publication
(10) Pub. No.: US 2008/0243544 A1
(43) Pub. Date: Oct. 2, 2008

(54) FIRST-ON METHOD FOR INCREASING COMPLIANCE WITH HEALTHCARE SELF-REPORTING

(76) Inventor: Jason Edward Cafer, Columbia, MO (US)

Correspondence Address: KIMSEY PATENT SERVICES, LLC, 804 SHAMROCK AVENUE, BOONVILLE, MO, 65233, US

(21) Appl. No.: 11/933,323

(22) Filed: Oct. 31, 2007

Related U.S. Application Data
(63) Continuation-in-part of application No. 11/695,050, filed on Apr. 1, 2007.

(51) Int. Cl. G06Q 10/00

(52) U.S. Cl. 705/2

(57) ABSTRACT

A first-on method for improving user compliance with self-reporting in a healthcare environment. The method includes the step of presenting a user with a self-reporting requirement associated with an electronic functionality desired by said user, the user being required to satisfy the self-reporting requirement prior to accessing the electronic functionality. The self-reporting requirement is presented to the user upon initiation of the desired electronic functionality.

### CROSS-REFERENCE TO RELATED APPLICATIONS

This Application is a Continuation-In-Part of U.S. patent application Ser. No. 11,695,050 filed on Apr. 1, 2007, and incorporated by reference herein in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

The present invention pertains generally to the medical and mental health professions, and more specifically to a method and system for ensuring a greater degree of reliable self-reporting by patients undergoing treatment or care by a medical or mental health care provider.

Patient self-reporting is an important part of any health treatment regimen, particularly in the mental health care professions. The ability of a provider to compile detailed information about a patient's well-being, habits, thoughts, or compliance with treatment regimens when the patient is away from the physician or health care provider is invaluable to the provider and to the well-being of the patient. One primary drawback to any patient self-reporting regime is the patient's unwillingness or neglecting to comply with the self-reporting. Patients are often not motivated to comply because of the effort required in doing so, even when that effort is minimal.

Lack of compliance with a self-reporting regimen not only provides a physician or other health care provider with a gap in the information pertaining to the patient, it may, in some cases, provide erroneous information. A patient who is required to undertake self-reporting but has not done so may, out of embarrassment, hastily compile a self-reporting disclosure for the physician or provider immediately prior to an appointment. In such a case, it is likely that the patient will misremember the nature, severity, time, or other important details concerning the event or events being reported. In many ways, such information may be more detrimental to the provider than having no information at all because it may lead the provider to act upon erroneous information.

What is needed, therefore, is a method that provides a patient with an easy way to engage in self-reporting, provides a patient with the motivation to comply with the self-reporting, and allows a physician to easily monitor the compliance with self-reporting and obtain the results thereof.

### BRIEF SUMMARY OF THE INVENTION

The present invention provides a first-on method for improving user compliance with self-reporting in a healthcare environment. The method includes the step of presenting a user with a self-reporting requirement associated with an electronic functionality desired by said user, the user being required to satisfy the self-reporting requirement prior to accessing the electronic functionality. The self-reporting requirement is presented to the user upon initiation of the desired electronic functionality.

In one aspect of the present invention the electronic functionality is selected from the group consisting of an electronic device, an application associated with an electronic device, and a functionality of an already-running application associated with an electronic device.

In another aspect of the present invention the self-reporting requirement is presented to the user via a widget.

In still another aspect of the present invention the self-reporting requirement is satisfied by the user opting out of said self-reporting requirement.

In another aspect of the present invention the self-reporting requirement is satisfied by the user identifying at least one symptom experienced by the user.

In another aspect of the present invention the self-reporting requirement is satisfied by said user rating at least one symptom experienced by the user.

In another aspect of the present invention the self-reporting requirement is satisfied by the user reporting at least one event experienced by the user.

In another aspect of the present invention the electronic functionality is an electronic device selected from the group consisting of a desktop computer, a television, a digital video recording device, video game device, and a digital audio recording device.

In another aspect of the present invention the electronic functionality is a mobile electronic device.

In another aspect of the present invention the mobile electronic device is selected from the group consisting of a PDA, a cell phone, a smart phone, a digital music player, a portable video game device, a mobile video recording device, and a mobile audio recording device.

In another aspect of the present invention the self-reporting requirement is presented within a third-party application and the electronic functionality is a functionality of the third-party application.

### BRIEF DESCRIPTION OF THE DRAWINGS

FIG. 1 is a schematic diagram of an exemplary mobile device adapted for use with the present method.

FIG. 2 is a schematic diagram illustrating a basic functionality of the present method.

### DETAILED DESCRIPTION OF THE INVENTION

Before turning to a detailed description of the invention, below, a brief explanation of some of the terminology contained within this application is provided. The terms ‘user’ and ‘patient’ are generally interchangeable as used herein, referring to an individual having a desktop computer, PDA or other device adapted for use with the present system. The acronym PDA, which stands for Personal Digital Assistant, is functionally interchangeable with any suitable mobile electronic device including, but not limited to, a cell phone or smart phone, MP3 player, or mobile video game device. The term ‘application,’ as used herein, refers to any program, in a broad sense, that provides instructions to a computer and performs a task for an end user. Thus, an ‘application,’ as used herein, includes, for example, anything from a program that provides a digital cable menu on a television screen, to a word processing program, to a program that allows recoding of television such as via TiVO®, to a program for playing music or video games on a computer. Any of these, and any other program that provides functionality for an end use, is considered an ‘application’ as that word is used herein. The term “first-on” and variations thereof may refer to powering on of a device such a computer or mobile device, or may refer to launching or attempting to launch a computer application. The present method is referred to herein as both a method and a system.

The term ‘electronic functionality’ is used herein to indicate generally any electronic functionality desired to be accessed by a user, including the functionality provided generally by an electronic device, or the specific functionality of an application within an electronic device. The ‘initiation’ of said electronic functionality may refer to the powering on of an electronic device or the launching of any application contained within an electronic device.

It is contemplated that the present invention, as described below, may be implemented on any suitable device, irrespective of the particular operating system used by the device. Examples of operating systems that may be used to employ the present invention are any of the various Windows operating systems, MacOS, Linux, and the like. For mobile devices adapted for use with the present system, operating systems may include, for example, Windows Mobile, Symbian OS, Palm OS, Mobile Linux, and MXI. Any other suitable operating system may be used, however. Likewise, the present invention is not limited to any given hardware configuration or specifications. Any device having hardware suitable for providing the functionality of the present system may be utilized. It is contemplated that numerous versions of the present system may be implemented in various ways, with each implementation being designed to work with a specific device and the hardware specifications thereof.

As noted above, patient self-reporting is an important part of any treatment regimen, particularly in the mental health care professions. Patient compliance with self-reporting, however, is often less than desirable. The present system and method provides a novel, innovative way to increase patient compliance with self-reporting through the use of an electronic device, such as a desktop computer, television, video game unit, or other device, or portable electronic devices such as a personal digital assistant (PDA), cell phone, MP3 player, portable video game device, or other mobile devices.

In one aspect of the present invention wherein a mobile device is used, a patient utilizing the present system receives a PDA or other mobile device that is in communication with the present system and adapted to provide information thereto. The PDA or other mobile device may be provided by a physician treating the patient, or may be provided by a company or other entity administering the present system. In most ways, the PDA functions as a normal PDA, giving the patient an incentive to use the device to access the desired features contained therein to ensure that the patient will desire using the device. The device, however, also acts as a self-reporting mechanism, and more importantly a mandatory self-reporting mechanism that is not overly oppressive from the patient's point of view. In another aspect of the present invention, a patient's own pre-existing mobile device may be used in conjunction with the present system. When the patient's own device is being used, whether the device is mobile or not, the patient may be required to download and install software to provide the needed functionality to the device. Alternatively, the patient may give the device to the treating physician or to representatives of the company or entity administering the present system, whereupon the device can be modified as needed for use with the present system. The description of the present invention herein refers often to a physician or other health care professional, but it is contemplated that any suitable person may fill an analogous role depending on the particular field of use in which the invention is applied. For example, the analogous role may be filled by an evaluator, analyst, life coach, teacher, parole or probation officer, or any other suitable person. Although the present invention is described below for use with a PDA associated with the present system, it is contemplated that any suitable device may be adapted for use with the present system. Further description of use of the present system with other mobile or non-mobile devices is also provided below.

Turning now to a mobile embodiment of the present invention, wherein a PDA is adapted for use with the present system, an exemplary description of the present system is provided. Any time a patient turns on a PDA or other mobile device associated with the present system, a first-on feature of the present system is initiated, and the PDA presents the patient with a short series of questions that must be answered prior to accessing the electronic functionality desired by the patient. The electronic functionality desired by the user may be the general functionality of the device itself or the specific functionality of any application contained within the device. The questions may, for example, ask the patient to rate numerically her average levels of anxiety or frustration over the previous week. Once the patient answers the questions, the PDA exits the question screen immediately, allowing the patient to use the PDA. In an alternative embodiment of the present system, the patient may exit the questions displayed at startup by simply choosing the exit function, whether the questions are answered or not, however in such embodiments choosing the exit function preferably results in a delay before the patient can access the functionality of the PDA, thereby giving the patient an incentive to answer the questions because answering the questions will lead to quicker access to the PDAs other functions. Further, it is contemplated that in a preferred embodiment the PDA will enter a sleep mode if not used for a period of time, and that mandatory questions will be presented when the PDA ‘wakes up,’ from sleep mode (by being used again). Thus a patient may not avoid the self-reporting questions by simply leaving the PDA on for long periods of time.

In addition to the mandatory questions presented at start up, a PDA of the present system preferably further contains an at-will self-reporting feature, whereby a patient may at any time report an event to the present system. The system will prompt the patient to answer certain questions regarding the type of event being reported, the time of occurrence of the event, the severity of the event, or for any other information deemed pertinent to the self-reporting. The patient may also be provided with the option of taking a full symptom inventory or, alternatively, a brief symptom inventory, depending on the level of reporting desired by the patient. The present system saves the responses to such questions, thereby creating a type of health status ‘journal’ which can later be reviewed with respect to any given timeframe. In addition to saving the responses for later access by a physician, the present system may also transmit the information to database accessible by the physician so that the physician is able to obtain the date prior to a next appointment with the patient. In the situation wherein information is automatically transmitted to a database for use by a physician, it is not necessary for a physician to manipulate the mobile device in any way.

Results of the patient's self-reporting activity are assimilated by the present system for input as described above. Events reported will appear, for example, in a patient history, electronic medical record, or other database such that the information can be accessed by the patient's health care provider. Concerns or questions may also be expressed by the patient using the PDA, the concerns or questions being stored for review by the patient's physician or being transmitted to a database to which the physician has access. Upon reviewing the information immediately prior to the next session with the patient, a physician utilizing the present system receives a detailed representation of the current mental and physical state of the patient, as well as the mental and physical state of the patient during the time interval between the last session and the current session.

Information obtained by the present invention as a result of a patient's self-reporting activity is preferably that information that is most pertinent to a health care provider treating that patient. The health care provider may determine which questions are asked of a patient, and how often the questions are posed. The health care provider may also customize the question regimen of a given patient such that the mobile device carried by that patient and associated with the present system provides the patient with questions uniquely or particularly suited to that patient. The health care provider may determine which questions are to be asked by entering such information into the mobile device directly, such as when a patient is present for an office visit with the physician, or may provide the information remotely, such as via the internet or a wireless connection. If the internet is used, it is contemplated that the patient may be prompted to download the information from an internet site, either wirelessly or by plugging the mobile device into a computer by use, for example, of a USB or Bluetooth connection. A mobile device used in conjunction with the present system may also be adapted to automatically check for updates when plugged into a computer connected to the internet, or to automatically download updates from a wireless source.

As noted above, any suitable mobile device may be adapted for use with the present invention. The type of device used may ensure greater compliance among certain patient demographics. For example, in a situation wherein a child or adolescent is utilizing the present system, wherein the patient may not use a PDA or may be tempted to bypass the question answering function of a device of the present system (if such an option is possible), it is contemplated that utilizing a smart phone, MP3 player, or mobile video game device may be more productive. The various options provided by the device, such as whether to avoid answering questions, may be set by the patient's parents or guardians, or by a physician treating the patient. In the situation wherein a mobile video game device is utilized, for example, when a patient first powers on the video game device the patient is presented with questions or other prompts requiring a response (such as a mood or symptom rating activity) that must be adequately addressed prior to activating the gaming functionality of the device. Likewise, with an MP3 player the user must complete certain tasks prior to accessing the music-playing functionality of the device. These devices may be adapted to store the responses for latter access by a physician, or may be adapted to transmit the information to a database accessible by a physician over the internet, such as when the device is connected to a computer that is in turn connected to the internet, or wirelessly. Whether the mobile device employed is a PDA, smart phone, MP3 player, mobile video game device, or other mobile device, it is contemplated that the device can be adapted to have the same or similar functionality.

Although the description above has been directly primarily to aspects of the present invention wherein a patient is answering questions concerning physical or mental health, it is contemplated that a patient may also perform other actions, such as choose symptoms experienced by the patient and/or rank the severity of symptoms using any suitable symptom ranking scale. Further, the patient may report significant events such as accidents, life events, and the like that have occurred at or around the time of reporting. Any of these or other reporting activities may be referred to generally as self-reporting requirements. Even though the general phrase ‘self-reporting requirement’ may be used, however, it is contemplated that in some aspects of the present invention the ‘requirement’ may be satisfied by selecting an opt-out option as further described herein.

Reciprocal Reporting

As described above, a patient is able to report events using a first-on self-reporting feature associated with a patient's PDA or other mobile device, or by using the at-will self-reporting feature of a PDA or other mobile device. In addition to this feature of the present system, as described above, some embodiments of the present invention include a reciprocal reporting feature by which a patient is able to report not only with respect to him- or herself, but with respect to other patients for whom that first patient is authorized to report. The output of this reporting is routed to the appropriate electronic medical record or other database rather than being entered into the record of the reporting patient. A digital image of the person whose behavior or symptoms are being reported is preferably displayed on the PDA screen so that the patient making the report does not inadvertently report on the wrong person. Under certain circumstances, the person reporting behavior or symptoms pertaining to another individual may be required to verify her identity by speaking a specified word or phrase into a webcam, with voice and visual data archived for later use if the identity of the person reporting behavior or symptoms is called into question. This security provision may be used to address, for example, individuals making false collateral input for the purpose of obtaining controlled substances. Other security measures, such as the use of passwords for example, may also be provided in conjunction with the present invention.

In addition to multiple patients having to ability to report on one another using the functionality of the present invention, it is further contemplated that permission to report on a patient may also be assigned to a family member, such as an adult child, a spouse, a parent, or the like. In such instances, the present system preferably includes an authentication method, such as by the use of a password or creation of a voice record, to ensure that the person making the report is authorized to do so. A physician having patients using the present system may designate which individuals are able to report on any given patient.

Whether a PDA or other mobile device adapted for use with the present system is in the hands of a patient or an individual having permission to report with respect to a patient, inadvertent reporting of events may be possible, particularly in embodiments of the present system wherein the mobile device has a touch screen. An inadvertent tap or touching of the touch screen may cause the device to erroneously record the touch as a reporting event. In such embodiments of the present invention, the present system may provide any suitable protection against such inadvertent touchings, including locking keys, the touch screen, or other functional aspects of the device until the same are unlocked by the user. Alternatively, a bulls-eye or other graphic may appear onscreen in a random or alternating location, requiring that the user touch the bulls-eye with a stylus or other instrument prior to answering the questions or engaging in other self-reporting activities. The random or alternating movement of the bulls-eye decreases the likelihood that an inadvertent touching will be interpreted by the present system as a purposeful touching because the inadvertent touching is not likely to correspond to the location of the bulls-eye.

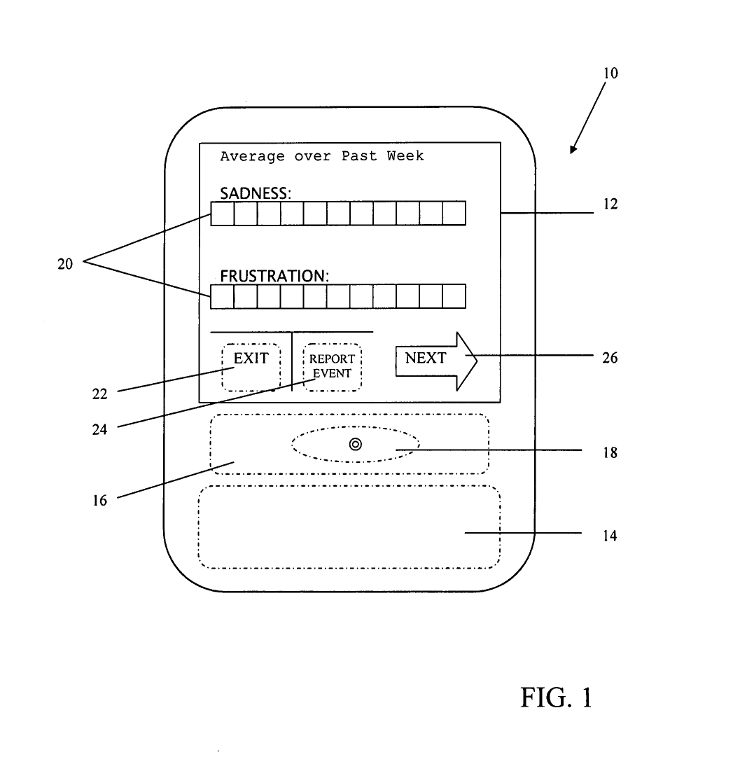

Having provided a thorough description of the functionality of the present system above, an exemplary description of a mobile device suitable for use with the present system is now provided with reference to FIG. 1. The figure provides a schematic diagram of an exemplary mobile device 10 showing an exemplary screen that a patient may be confronted with when mobile device 10 is first powered on or awakened from a sleep mode. It should be noted that mobile device 10 does not represent any particular mobile device on the market as of this writing, but rather serves as an example to display one functional aspect of the present system. The precise layout and character of any elements of mobile device 10 may vary widely from device to device, and it is contemplated that the present system may be used with any suitable mobile device 10 and is not limited to any given device, layout, key functionality, or the like.

Display area 12 represents a screen, whether a touch screen or otherwise, typically associated with a device such as mobile device 10. Keyboard area 14 typically contains keys corresponding to digits from one to nine, letters of the alphabet, various grammatical or other symbols, and functional keys such as a shift key, space bar, and the like. The keys provided in keyboard area 14 may vary from device to device. Key area 16 typically provides other functional keys not included as part of keyboard area 14, such as, for example, keys relating to the volume of the device, background illumination, power, other useful aspects of the device such as entering a telephone mode, and the like. Cursor movement area 18 typically allows movement of a cursor across display area 12 in versions of mobile device 10 that do not have a touch screen, or when a user of mobile device 10 is using the device without a stylus or other instrument for touching the screen.

As shown in FIG. 1, a patient is asked, upon first turning on mobile device 10, to rate average levels of sadness and frustration over the previous week. The patient is provided with rating boxes 20, which may, for example, contain numbers ranging from zero, at the far left, to ten at the far right. For ease of viewing the drawing, the numerical ratings are not included in FIG. 1. Using a stylus or other instrument, or by manipulating a cursor via cursor movement area 18, a patient may select the appropriate rating for each of these subjective feelings.

First selection area 22 provides additional functionality to the patient. In the embodiment of the present system shown in FIG. 1, for example, first selection area 22 allows a patient to exit the self-reporting functionality of the device. As discussed above, it is preferred that there be some delay in access the other functionality of mobile device 10 should a patient chose to bypass the self-reporting feature, in order to provide an incentive for the patient to comply with the self-reporting feature. In some embodiments of the present invention, the exit functionality may be removed such that the patient cannot bypass the self-reporting functionality. This may be most useful, for example, with an MP3 player or mobile video game unit being utilized by a child, such that a parent or physician can optionally disallow access to the desired functionality of the device until the self-reporting requirement has been satisfied.

Second selection area 24 allows a patient to report a specific event instead of, or in addition to, the subjective ranking of sadness and frustration provided onscreen in FIG. 1. If selection area 24 is touched with a stylus or chosen in another manner, another screen is preferably displayed, this screen allowing the patient to choose from a list of reportable events such as, for example, a panic attack, food binge, alcoholic binge, argument, or other event. If a patient chooses ‘other event,’ the patient is preferably provided with a text box wherein, using a stylus or a keyboard associated with mobile device 10, the patient is able to describe the event being reported. After the event has been chosen or described, the patient is preferably presented with another screen that allows the patient to choose the amount of time that has elapsed since the event, or to identify the date on which the event occurred if the vent is more than twenty-four hours old.

In the embodiment of the present system shown in FIG. 1, third selection area 26 allows a patient to move away from the screen shown in FIG. 1 once the subjective ratings for sadness and frustration have been chosen. When the patient chooses third selection area 26, labeled as ‘next’ in the drawing, the patient may either be confronted with additional self-reporting questions or ranking, or may be allowed to immediately access the other desired functionalities of device 10. Whether additional questions are presented and, if so, the character or nature of those questions, is preferably determined by a physician or health care professional. Alternatively, based upon a patient's response to the self-reporting requirement, the present invention may instruct the patient to undertake an activity, such as increasing or decreasing medication dosage, calling a physician or other health care professional, or schedule an appointment with a physician or other health care professional.

In another aspect of the present invention, a patient may be provided with the option of taking a full symptom inventory, if the patient desires to do so. It is contemplated that a patient will not typically take a full symptom inventory every time mobile device 10 is powered on, although a physician or other provider could require the present system to prompt the patient to take a full inventory every time mobile device 10 is powered on. Should a patient choose a full symptom inventory, the patient is preferably provided with a succession of screen in display area 12 for the purpose of indicating symptoms experienced by the patient, ranking the symptoms, or providing other pertinent information to the present system. The list of symptoms, rankings, or other information from which the patient can choose may be set by a physician or other health care provider.

Non-Mobile Aspects

Although exemplary aspects of the present invention have been described above with respect to a mobile embodiment of the present system, the system, including reciprocal reporting features thereof, may be implemented for use with non-mobile devices as well. The user-desired electronic functionality, including applications associated with non-mobile devices such as, for example, desktop computers, may be accessible to a user of the present system only after the user first satisfies the self-reporting requirements of the present system.

In an aspect of the present system adapted for use with a desktop computer, for example, a user of the present system may be provided with a self-reporting requirement that must be satisfied before the use can access the desired functionality associated with the computer. In such an embodiment of the present invention, the present system may be adapted to launch immediately upon booting the computer. Alternatively, or in addition to the above, the present system may be adapted to present a user with a self-reporting requirement any time the user launches an application such as word processing software, a computer video game, an internet browser, or any other computer software contained on the desktop computer with which the present system is being utilized. In such an embodiment of the present system, the user must satisfy the self-reporting requirement of the present system before the software the user has attempted to launch is allowed to launch by the computer. Additionally, when a computer enters a stand-by, sleep, or hibernation mode (which terms are used interchangeably herein), the user may be presented with a self-reporting requirement upon waking the computer, which requirement must be satisfied before the computer will allow the user to again access the full functionality of the machine. The functionality described here, of course, applied equally well to laptop or handheld computers. Further, with respect to PDAs, smart phones, or any other mobile devices, the self-reporting requirement of the present system may be initiated upon the launching of any software or other application associated with the device. In any of the embodiments of the present system described herein, and optional opt-out may also be provided whereby the user can circumvent the self-reporting requirement of the present system.

The present system may also be adapted for use upon launch of a second application being launched within a first application. This situation may arise, for example, in the situation wherein a web-based application is launched within an internet browser. Under this aspect of the present system, the user is preferably provided with a self-reporting requirement (either within the internet browser or outside of it) that must be satisfied prior to accessing the desired functionality provided by the web-based application being launched.

In addition to the above, the present system may be provided in the form of a widget or other functionality contained within an application associated within an electronic device. For purposes of this disclosure, a widget is defined broadly as a graphical object, such as one associated with a graphical user interface, that may be manipulated by a user. The widget may be in the form of an on-screen control and may hold data for presentation to a user or a physician or other health care provider.

Whether in the form of a widget or otherwise, the present system may be adapted for use within an already-running application, the initiation or first-on aspect of the system being the accessing or attempted accessing of a given functionality within that already-running application. In such aspects of the present system, it is contemplated that the present system may be adapted for use within third-party applications, such as Facebook®, for example, where the third-party application has been launched and the present system is provided within that third-party application. Thus, when a user attempts to access given functionality of the third-party application (by initiation or attempted initiation of that functionality) that the user is already accessing, the present system presents the user with a self-reporting requirement.

In an aspect of the present invention wherein a third-party application such as Facebook® is utilized, there is an added layer of privacy or protection in place stemming from the fact that the third-party application is protected by a password. Thus, the widget or other application associated with the present system may be displayed only when a user logs into the third-party application with the appropriate password. A physician, evaluator, probation officer, or other such person may prescribe or require that a user adopt the widget or other application implementing the present system for use in such a third-party software environment. The self-reporting requirement of the present invention acts almost as a second password for accessing the functionality of the third-party application, as the user must satisfy the self-reporting requirement prior to being able to access the functionality of the third-party application.

Other examples of the present system as implemented in non-mobile devices include, for example, implantation in association with digital cable television or a device for recording television such as TiVo®. In such an aspect of the present invention, the user is provided with a self-reporting requirement that must be satisfied prior to accessing a feature of the digital cable television or digital television recording device. It is contemplated that in the situation where such devices are connected to the internet, the user's self-reported data may be automatically provided to a physician or other health care provider. In the situation where any of the embodiments of the present invention are utilized in connection with devices not connected to the internet, it is contemplated that the user's self-reporting data may be transferred to any form of storage medium, including CD-ROM, DVD-ROM, Flash Drive, or any other suitable medium for later transport to a physician or other health care provider. In situations wherein mobile devices are used the user may, as described above, relinquish the entire device to a physician or other health care provider for accessing the data contained therein.

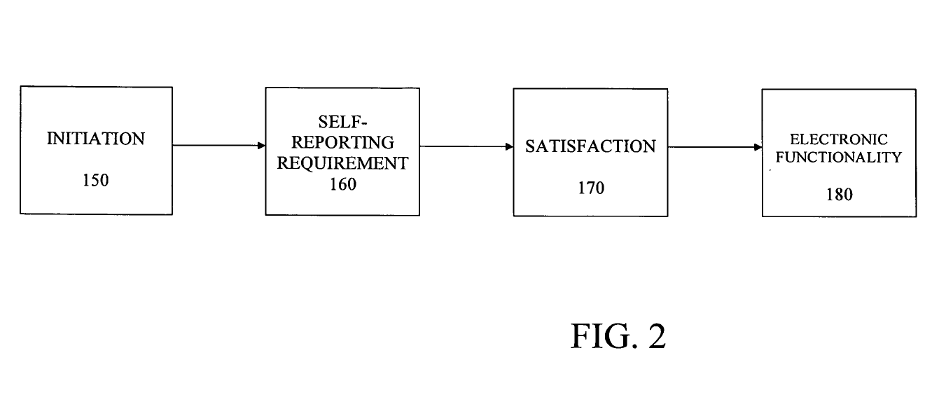

FIG. 2 illustrates a basic functionality of the present method across the various exemplary implementations of the present method described herein. Box 150 represents initiation, which includes any action on the part of a user to access or attempt to access a desired electronic functionality of a device or application. Initiation 150 may include, for example, turning on an electronic device, launching or attempting to launch an application, or accessing or attempting to access functionality within an already-running application.

Upon an initiation event by a user, the present method presents the user with a self-reporting requirement, as represented by box 160. The self-reporting requirement may be the provision of any suitable self-reporting information such as, for example, symptom tracking, symptom ranking, reporting and event, or providing any other information needed or desired by a physician or other health care professional treating the user.

The self-reporting requirement presented to the user and represented by box 160 must be satisfied by an action of the user, as represented by box 170. It is preferred that the user action that satisfies the self-reporting event is the reporting of information requested from the user by the present method. Alternatively, in embodiments of the present invention wherein there exists an opt-out option to allow a user to circumvent self-reporting, then selection of an opt-out option will, for purposes of this writing, ‘satisfy’ the self-reporting requirement.

Once the self-reporting requirement has been satisfied, a user is able to access the desired electronic functionality, as represented by box 180. The electronic functionality may be as broad as the general functionality of the electronic device when the device is turned on, such as, for example, simply viewing an image when a television is turned on. Alternatively, the electronic functionality may be launching an application contained within an electronic device or accessing specific functionality of an application that is already running.

It is contemplated that upon reading this disclosure one of skill in the art could reasonably adapt the principles of the present invention to various other art areas, and such uses of the principles of the present invention are considered to be within the spirit and scope of the present invention. In such other systems, the individual analogous to the ‘patient,’ referred to above with respect to health care-related embodiments of the present invention, may be referred to as the ‘client’ of a user of said system.

The detailed description set forth above is provided to aid those skilled in the art in practicing the present invention. The invention described and claimed herein, however, is not to be limited in scope by the specific embodiments disclosed because these embodiments are intended to be illustrative of several aspects of the invention. Any equivalent embodiments are intended to be within the scope of the present invention. Various modifications of the invention that do not depart from the spirit or scope of the present invention, in addition to those shown and described herein, will become apparent to those skilled in the art from the foregoing description. Such modifications are also intended to fall within the scope of the appended claims.

1. A first-on method for improving compliance with self-reporting, the method comprising the step of presenting a user with a self-reporting requirement associated with an electronic functionality desired by said user, said user being required to satisfy said self-reporting requirement prior to accessing said electronic functionality, wherein said self-reporting requirement is presented to said user upon initiation of said electronic functionality.

2. The method according to claim 1 wherein said electronic functionality is selected from the group consisting of an electronic device, an application associated with an electronic device, and a functionality of an already-running application associated with an electronic device.

3. The method according to claim 1 wherein said self-reporting requirement is presented to said user via a widget.

4. The method according to claim 1 wherein said self-reporting requirement is satisfied by said user opting out of said self-reporting requirement.

5. The method according to claim 1 wherein said self-reporting requirement is satisfied by said user identifying at least one symptom experienced by said user.

6. The method according to claim 1 wherein said self-reporting requirement is satisfied by said user rating at least one symptom experienced by said user.

7. The method according to claim 1 wherein said self-reporting requirement is satisfied by said user reporting at least one event experienced by said user.

8. The method according to claim 2 wherein said electronic functionality is an electronic device selected from the group consisting of a desktop computer, a television, a digital video recording device, video game device, and a digital audio recording device.

9. The method according to claim 2 wherein said electronic functionality is a mobile electronic device.

10. The method according to claim 9 wherein said mobile electronic device is selected from the group consisting of a PDA, a cell phone, a smart phone, a digital music player, a portable video game device, a mobile video recording device, and a mobile audio recording device.

11. The method according to claim 1 wherein said self-reporting requirement is presented within a third-party application and further wherein said electronic functionality is a functionality of said third-party application.

12. The method according to claim 1 wherein at least a portion of a content of said self-reporting requirement is provided by a physician treating said user.

13. The method according to claim 1 further comprising the step of transmitting to a predetermined computer on a network, including the internet, at least one result of said self-reporting requirement.

14. The method according to claim 1 wherein said user is not a patient with respect to whom said self-reporting requirement pertains, and further wherein said user is an individual authorized to satisfy said self-reporting requirement with respect to the patient to whom the self-reporting requirement pertains.

15. The method according to claim 1 wherein said initiation of said electronic functionality comprises waking an electronic device from a sleep mode.

16. The method according to claim 1 wherein at least a portion of a content of said self-reporting requirement is providing by an individual selected from the group consisting of an evaluator, an analyst, a counselor, a life coach, a teacher, a parole officer, and a probation officer.

17. The method according to claim 4 wherein when said self-reporting requirement is satisfied by said user opting out of said self-reporting requirement, a delay is provided prior to allowing said user to access said electronic functionality.

18. The method according to claim 11 wherein said third-party application is protected by a password, and further wherein said self-reporting requirement is presented to said user only when said user logs in to said third-party application using an appropriate password.

19. The method according to claim 1 further comprising the step of presenting said user with additional instructions after said user satisfies said self-reporting requirement.

20. The method according to claim 19 wherein said additional instructions are selected from the group consisting of increasing medication dosage, decreasing medication dosage, calling a physician, calling a non-physician health care provider, and scheduling an appointment with a health care provider.
